(19) United States
(12) Patent Application Publication
(10) Pub. No.: US 2007/0240170 A1
(43) Pub. Date: Oct. 11, 2007

(54) Computer implemented method and system for processing an event notification within a notification infrastructure of a database system using a persistent queue

(75) Inventors: Kapil Surlaker, Mountain View, CA (US); Shailendra Mishra, Fremont, CA (US)

Correspondence Address: WAGNER, MURABITO & HAO LLP, Third Floor, Two North Market Street, San Jose, CA, 95113, US

(73) Assignee: ORACLE INTERNATIONAL CORPORATION, REDWOOD SHORES, CA (US)

(21) Appl. No.: 11/401,658

(22) Filed: Apr. 10, 2006

(51) Int. Cl. G06F 9/46

(52) U.S. Cl. 719/318

(57) ABSTRACT

A computer implemented method for processing an event notification within a notification infrastructure of a database system based on a client specified quality of service designation. The designation may indicate reliable transmission in which case a persistent internal queue is used. The method includes enqueuing an event notification into a persistent internal queue of said database notification infrastructure provided the client specified quality of service designation indicates reliable event notification. The event monitor then notifies the specified subscribers of the event notification. The reliable quality of service designation can be made at event registrations.

### FIELD OF THE INVENTION

Embodiments of the present invention generally relate to information management systems, and more particularly, to a computer implemented method and system for processing an event notification within a notification infrastructure of a database system.

### BACKGROUND OF THE INVENTION

A database system is an organized body of related information. Typically, a database stores a variety of information for an entity. Frequently, a database has different clients that access it for different reasons. Some database users, for example, are interested in changes that occur in a database. A change in a database can be significant or minor and may be called an event. Normally, a database user is not interested in every event that occurs in a database. More likely, a database user is only interested in the occurrence of certain database events. As a consequence of this need, database notification infrastructures allow database users to set up event registrations in which the clients can receive event notifications when certain database events occur. For example, a user can set up an event registration so that an event notification will be sent when an event notification is being enqueued and the message may indicate that a database change has happened.

FIG. 1 (Prior Art) illustrates a block diagram of a database system 100. Components of the database system 100 include database 105, database 110, database 115, database 120, and non-persistent shared memory 125.

Non-persistent shared memory 125 is located within database 120. Databases 105, 110, 115, and 120 are communicatively coupled to non-persistent shared memory 125. Various forms of information, such as event notifications for databases 105, 110, 115, and 120 may be stored within non-persistent shared memory 125. Event notifications are generated with an event notification infrastructure of the database. If database 120 goes down, then the information stored on the non-persistent shared memory 125 by databases 105, 110, 115, and 120 may be lost, including queued event notifications. Upon system start up, these queued event notifications never catch the internal subscriber.

Also, it is appreciated that the non-persistent memory 125 can be implemented in many ways. For example, the non-persistent shared memory 125 can be a Static Random Access Memory (SRAM). In another example, the non-persistent shared memory 125 can be a Dynamic Random Access Memory (DRAM). In another example, the non-persistent shared memory 125 can be other types of volatile memory.

Traditionally, an event notification is stored in a non-persistent shared memory of the database after being generated but before being delivered to a database user. However, for a database user that desires reliable event notification, storing an event notification in a non-persistent shared memory may be inadequate. For example, if the database fails, then usually the event notifications stored in a non-persistent shared memory is lost and cannot be regenerated. Consequently, the database user may not receive the event notifications.

### SUMMARY OF THE INVENTION

Accordingly, a computer implemented method and system for processing an event notification within a notification infrastructure of a database system based on a client specified quality of service designation are disclosed. The method includes enqueuing an event notification into a persistent internal queue of said database notification infrastructure provided a client specified “quality of service” designation indicates reliable event notification. In case of system failure, events queued in the persistent internal queue are processed when the system restarts because the data is persistently stored.

In one embodiment, the method includes receiving an event registration, wherein the event registration specifies an event, subscribers, and a quality of service designation for the event. Also, the method includes detecting occurrence of the event, wherein the event corresponds to the event registration. Further, the method includes generating an event notification related to the event registration. This may involve an event monitor. Moreover, the method includes enqueuing the event notification into a persistent internal queue of the database notification infrastructure provided the quality of service designation indicates reliable event notification. An event monitor then transmits the event notification to the listed subscriber and will dequeue the event notification when it has been fully consumed.

In another embodiment, a computer system for processing an event notification within a notification infrastructure of a database system based on a client specified quality of service designation is disclosed. The computer system includes a processor. Also, the computer system includes a bus coupled to the processor. Moreover, the computer system includes a memory coupled to the bus for storing instructions that when executed by the processor implements a method of processing an event notification within a database notification infrastructure using a persistent internal queue. The method includes receiving an event registration, wherein the event registration specifies an event, subscribers, and a quality of service designation for the event. Also, the method includes detecting occurrence of the event, wherein the event corresponds to the event registration. Further, the method includes generating an event notification related to the event registration. This may use an event monitor. Moreover, the method includes enqueuing the event notification into a persistent internal queue of the database notification infrastructure provided the quality of service designation indicates reliable event notification. The event monitor then informs all pertinent subscribers of the event notification. After the event has been fully consumed it is dequeued from the persistent internal queue.

In addition, embodiments are also directed to a computer readable media implemented with methods as disclosed above.

Advantageously, should the database system or instance go down, the contents of the persistent internal queue are stored persistently. Upon system restart, notifications that are detected in the persistent queue are transmitted to the persistent subscribers.

### BRIEF DESCRIPTION OF THE DRAWINGS

FIG. 1 illustrates a block diagram of a database system, in accordance with the prior art.

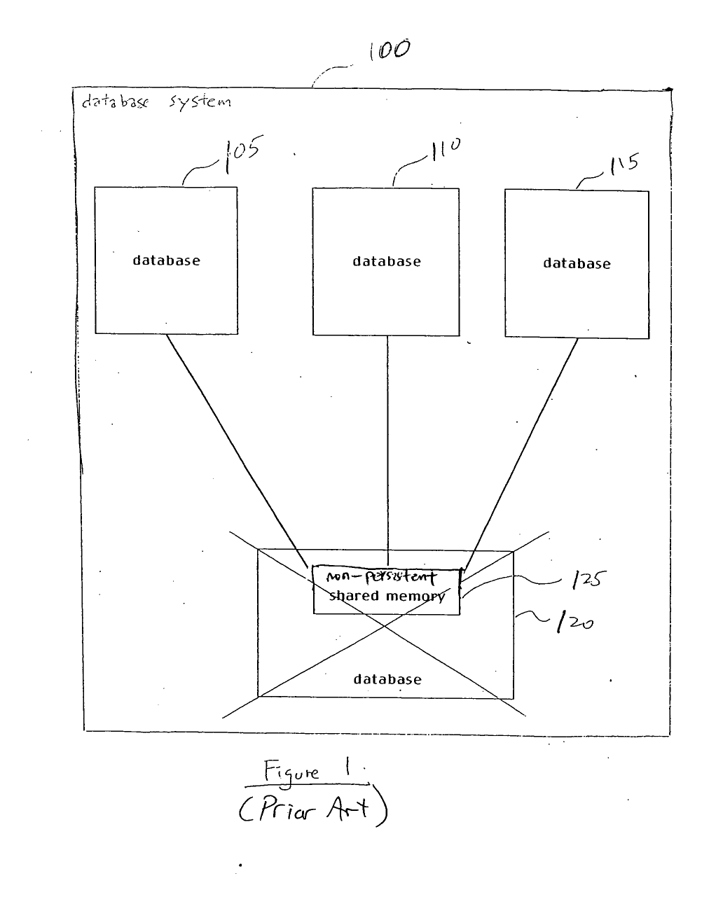

FIG. 2 illustrates a block diagram of an exemplary network environment upon which embodiments of the present invention can be implemented.

FIG. 3 illustrates a block diagram of the components of a database notification infrastructure, according to an embodiment of the present invention.

FIG. 4 illustrates a block diagram of the components of a database system, according to an embodiment of the present invention, including a persistent internal queue for reliable quality of service designations.

FIGS. 5A and 5B illustrate dataflow diagrams of an embodiment of the present invention in operation.

FIG. 6 illustrates a flowchart showing a computer implemented method for processing an event notification within a notification infrastructure of a database system, using a persistent internal queue for reliable quality of service designations, according to an embodiment of the present invention.

FIG. 7 illustrates a flowchart showing a method for an event monitor to remove an event notification from the persistent internal queue, according to an embodiment of the present invention.

FIG. 8 is a block diagram that illustrates a computer system upon which an embodiment of the invention may be implemented.

### DETAILED DESCRIPTION OF THE DRAWINGS

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

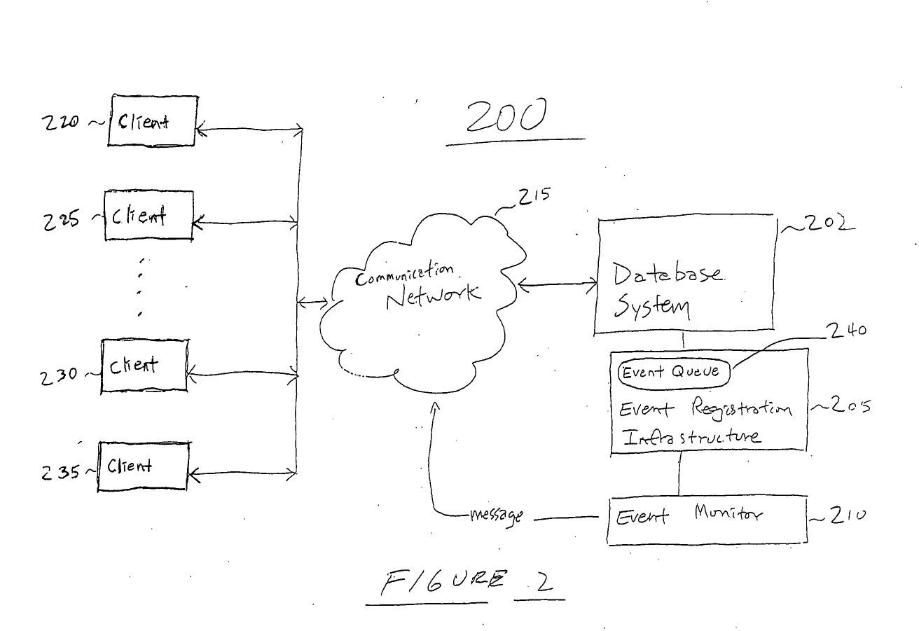

FIG. 2 illustrates a block diagram of an exemplary computer network environment 200 upon which embodiments of the present invention can be implemented. Components of the system for an event notification infrastructure include network 215, a database system 202, an event notification infrastructure 205, an event monitor 210, a communication network 215, and clients, e.g., client 220, client 225, client 230, and client 235. The database system 202 is an organized body of related information. The event notification infrastructure 205 is where event registrations are stored.

The event monitor 210 monitors the database for pertinent events and also performs the function of notifying relevant clients when certain events occur. In addition, incorporated herein by reference is U.S. Pat. No. 6,910,070 which further describes functions that may be performed by an event monitor 210. Also, it is appreciated that an event can be many things. For example, an event may be a change in a database and can be significant or minor. For example, an event can be a message being published for a subscriber and entered into a queue, an event may be instances or databases going up or down, or a change in database objects, or an explicit post for a certain entity. Events may be a number of well known database functions. Event notifications are messages sent to subscribers when related events occur that have been registered.

The network 215 is a data communications system that interconnects computer systems at various different sites. The network 215 can be implemented in a wide variety of ways. For example, network 215 can be implemented as, but is not limited to, a local area network (LAN), a metropolitan area network (MAN), a wide area network (WAN), and/or the internet. It is noted that the network environment 200 can also be implemented without network 215. As such, database system 202 and clients 220, 225, 230, and 235 can be communicatively coupled via wired and/or wireless communication technologies.

Each of the clients 220, 225, 230, and 235 may be communicating with the database system 202 through the network 215 that may include, for example, the Internet, a leased line and/or some other public, private, or hybrid network. Any of a number of well known communication links may be used. The database system 200 is coupled to the event notification infrastructure 205 and the event monitor 210. Clients 220, 225, 230, and 235 may each send an event registration to the event notification infrastructure 205 through network 215. After the event notification infrastructure 205 receives an event registration, the event registration will be logged into the event queue 240 of the event notification infrastructure. If an event specified in the event registration by a client occurs, the event monitor 210 will send a message, e.g., event notifications, through the network 215 to notify the relevant client. Clients that register for an event may be called subscribers for that event.

In addition, within FIG. 2, it is understood that network environment can be implemented to include greater or fewer number of clients than the four clients (e.g. 220, 225, 230, and 235) shown.

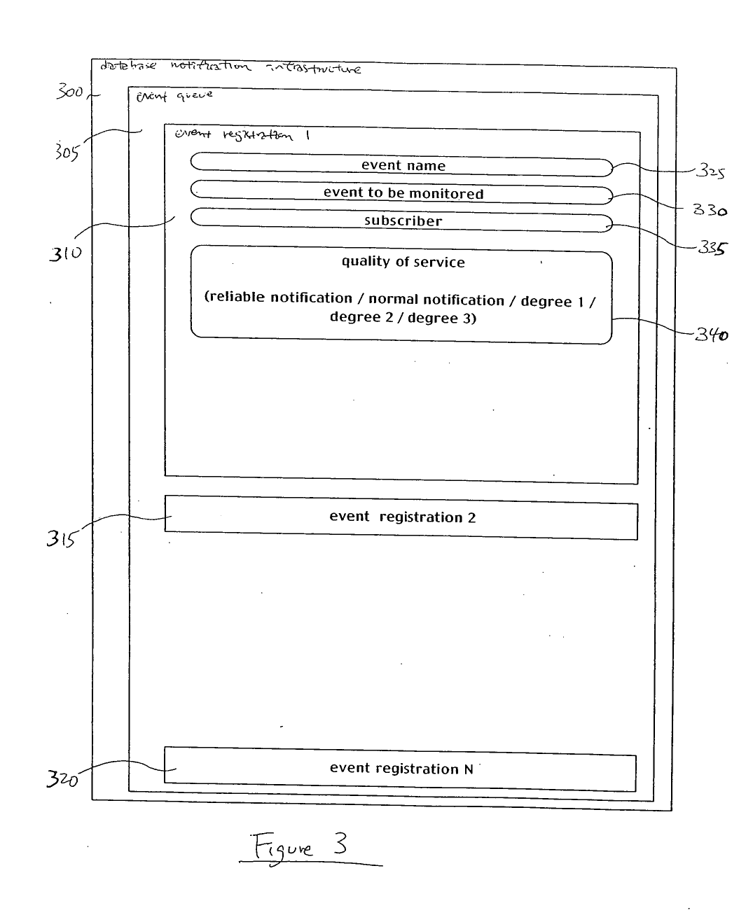

FIG. 3 illustrates a block diagram of the components of a database notification infrastructure 300, according to an embodiment of the present invention. The event queue contains registered events. As discussed more fully below, an event may be registered therein and specify a quality of service designation in accordance with an embodiment of the present invention. The components include the exemplary event queue 305, event registration1 310, event registration2 315, event registrationN 320, event name 325, event to be monitored 330, subscriber 335, and quality of service designation (reliable notification/normal notification/degree 1/degree 2/degree 3) 340.

The event queue 305 is located within the database notification infrastructure 300 and maintains a history of event registrations. Each event registration pertains to an event that is being monitored and specifies a number of fields including the event to be monitored, the pertinent subscriber, and a quality of service designation 340. In accordance with embodiments of the present invention, if the quality of service designation indicates reliable transmission, then any event notifications generated as a result of this event registration will be stored in a persistent event queue, e.g., a non-volatile storage medium. Furthermore, exemplary event registration1 310 through event registrationN 320 are stored within the event queue 305.

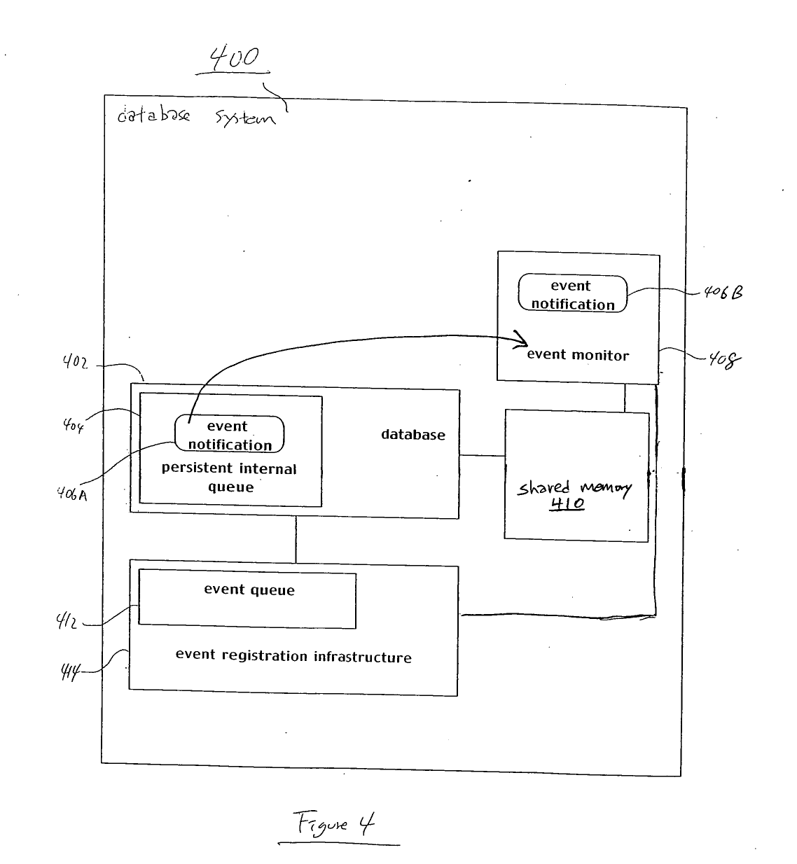

FIG. 4 illustrates a block diagram of the components of a database system 400, according to an embodiment of the present invention. The components include database 402, persistent internal queue 404, event notification 406A, event registration infrastructure 414, event queue 412, shared memory 410, event monitor 408, and event notification 406B.

The event monitor 408 and database 402 are communicatively coupled to shared memory 410. Also, the database 402 and event monitor 408 are coupled to event registration infrastructure 414. The event queue 412 is located within event registration infrastructure 414 and persistent internal queue 404 is located within database 402. Persistent internal queue 404 is implemented in non-volatile memory, e.g., hard drive storage.

The components of database system 400 cooperatively operate to process an event notification. Event queue 412 of event registration infrastructure 414 receives an event registration and event monitor 408 monitors for occurrences of an event that corresponds to the event registration. If an event that corresponds to the event registration is detected, then database 402 generates event notification 406A and 406B, according to parameters defined in the event registration. Event notification 406A is stored in persistent internal queue 404 because its associated event notification specified a reliable quality of service designation and event notification 406B is sent to event monitor 408 through shared memory.

Event registrations that do not specify a reliable transmission may have the associated event notifications stored in shared memory. The event monitor transmits the notifications to the pertinent subscribers. However, reliable quality of service designations mean the associated event notifications are stored in a persistent queue 404 and the event monitor again performs the function of informing the subscribers. The event monitor dequeues the messages when all subscribers have consumed the message. Also, the message is stored in the persistent queue before the associated transaction is committed.

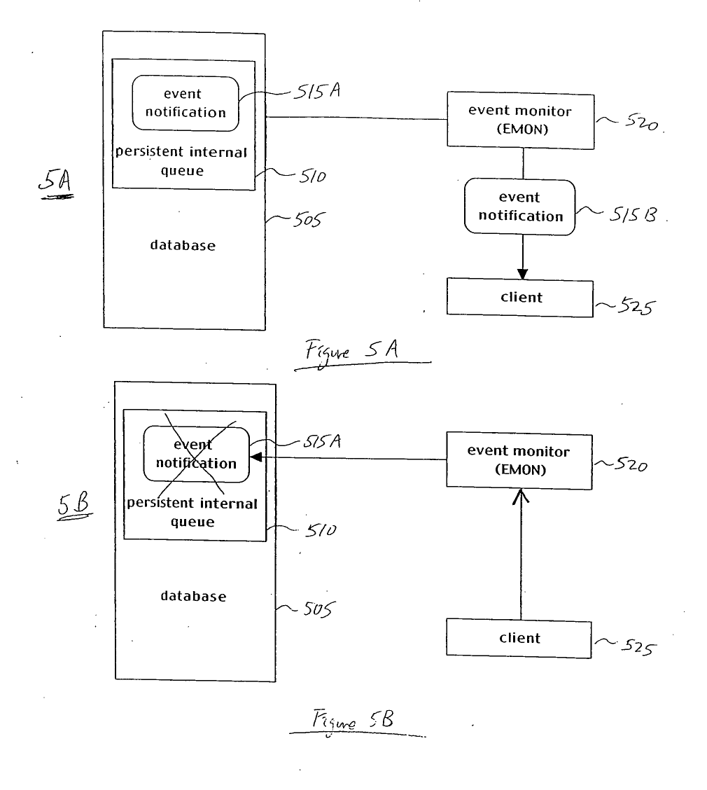

FIGS. 5A and 5B illustrate a specific embodiment of the present invention in operation. The components include database 505, persistent internal queue 510, event notification 515A, event monitor 520, event notification 515B, and client 525. The event notification 515A is stored on persistent internal queue 510 because the event registration that generated the notification specified reliable quality of service and the persistent internal queue 510 is located within database 505. Also, both database 505 and client 525 are communicatively coupled to event monitor 520.

As shown in FIG. 5A, the event monitor 520 sends event notification 515B to client 525. Further, as shown in FIG. 5B, the event notification 515A is removed from persistent internal queue 510 in response to the event notification 515B being delivered to all subscribers that required it, e.g., client 525. The client acknowledges the receipt of the message. It is appreciated that if the system hosting the persistent internal queue should fail, the contents of the persistent internal queue 510 would be immediately available upon system start-up. Also, in one embodiment, if a cluster is present, the contents of the persistent queue is made available to another node in the cluster. At this time, the event monitor 520 would scan the persistent internal queue 510 for messages that needed to be delivered to persistent subscribers.

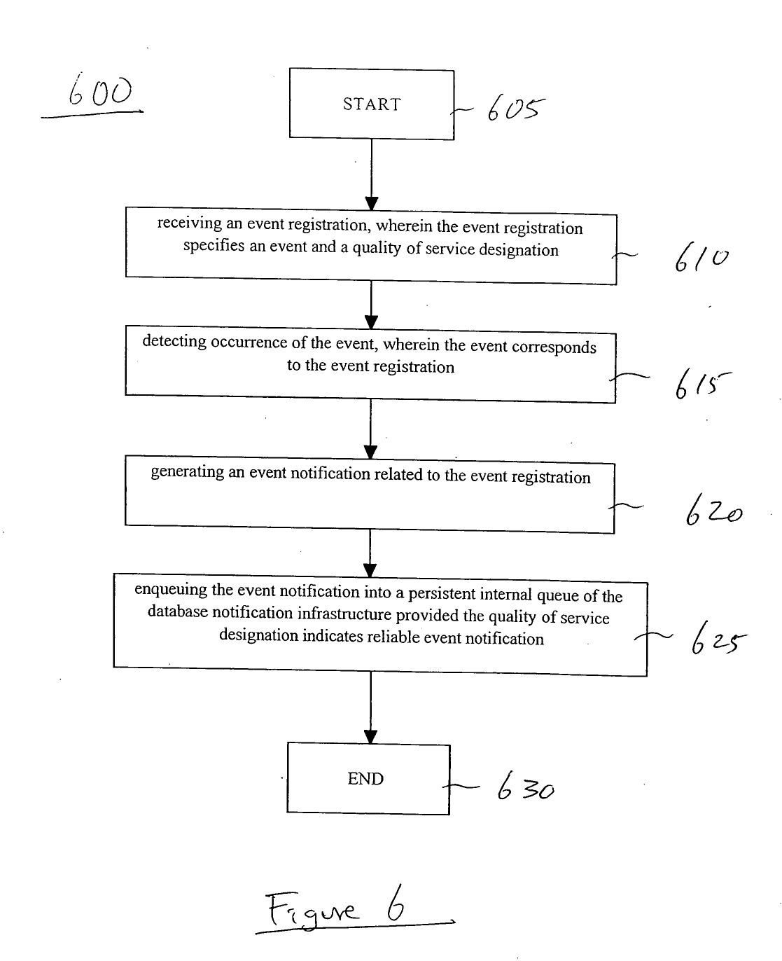

FIG. 6 illustrates a flowchart showing a computer implemented method 600 for processing an event notification within a notification infrastructure of a database system, according to an embodiment of the present invention. At block 605, the process starts.

At block 610, an event registration is received, wherein the event registration specifies an event and a quality of service designation. It is appreciated that the present invention is readily adaptable for implementation with a variety of quality of service designation. For example, the quality of service designation can be for reliable notification. If the client designates reliable notification, then the event notification will be stored in the persistent internal queue. In another example, the quality of service designation can be for normal notification. If the client designates normal notification, then the event notification will be stored in a volatile memory. In yet another example, different degrees of quality of service designation can be utilized.

At block 615, an occurrence of the event is detected, wherein the event corresponds to the event registration. It is appreciated that the present invention is readily adaptable for implementation with a variety of events. For example, an event may be a significant or a minor change in a database. In another example, an event can be a message being published for a subscriber and entered into a queue. In another example, an event may be instances or databases going up or down. In yet another example, an event can be a change in database objects. In yet another example, an event can be an explicit post for a certain entity. In still another example, an event can be a number of well known database functions. Also, it is appreciated that detecting can be performed in a variety of ways. In one example, detecting can be performed by the event monitor that monitors the database. In another example, detecting can be performed by a database program. In yet another example, detecting can be performed by a logical agent coupled to the database.

At block 620 of FIG. 6, an event notification or message related to the event registration is generated. It is appreciated that an event notification or message can be generated in a variety of ways. For example, an event notification can be generated by a database program. In another example, an event notification can be generated by a program coupled to the database.

At block 625, the event notification is enqueued into a persistent internal queue of the database notification infrastructure provided its associated event registration indicated a quality of service designation that was for reliable event notification. It is appreciated that the persistent internal queue can be implemented in many ways. For example, the persistent internal queue can be a magnetic disk. In another example, the persistent internal queue can be a magnetic tape or MRAM. In yet another example, the persistent internal queue can be a storage device built using materials that can be magnetized easily in only one direction (e.g. gadolinium gallium garnet). In still another example, the persistent internal queue can be other storage devices that preserve the storage devices' content when the storage devices' power is off. Any non-volatile memory may be used to provide storage space for the persistent internal queue. At block 630, the process ends.

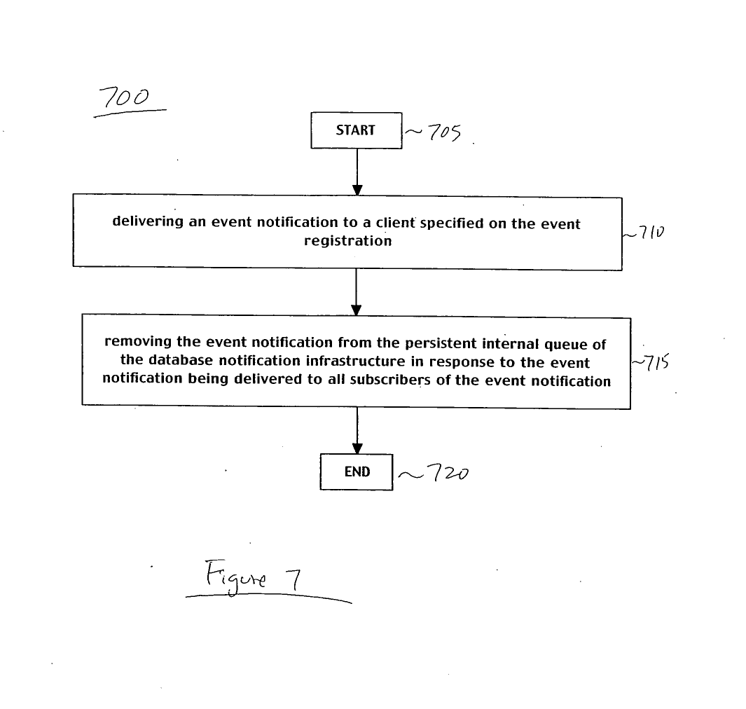

FIG. 7 illustrates a flowchart showing a method 700 for an event monitor to remove an event notification from the persistent internal queue, according to an embodiment of the present invention.

At block 705, the process starts. At block 710, an event notification is delivered to a client specified as a subscriber of the event on the event registration. The event notification can be readily implemented and delivered in accordance with a variety of communication techniques. In one example, the event notification can be delivered through a wireless connection and/or a wired connection. In another example, an event notification can be delivered via a secured connection that utilizes encryption. Also, it is appreciated that the event monitor can deliver the event notification with a variety of communication mechanisms. For example, the communication mechanism can be by electronic mail, http, delivery over a network to a user specified host and port, and invocation of a stored PL/SQL procedure. More than one subscriber can be defined for an event notification.

At block 715, the event notification is removed from the persistent internal queue of the database notification infrastructure in response to the event notification being delivered to all specified subscribers for the event notification. In one embodiment, the subscribers each send an acknowledgement message to the event monitor to indicated that they received the event notification. When all pertinent subscribers have sent such message, then the event notification is dequeued from the persistent queue. For purposes of the present invention, removal can be performed in many ways. For example, removal may mean that the event notification is flagged or marked as invalid but not immediately deleted from the persistent internal queue. In another example, removal can mean that the event notification is deleted form the persistent internal queue. Also, removal of the event notification can be simultaneous or delayed with respect to the event notification being delivered to the client. At block 720, the process ends.

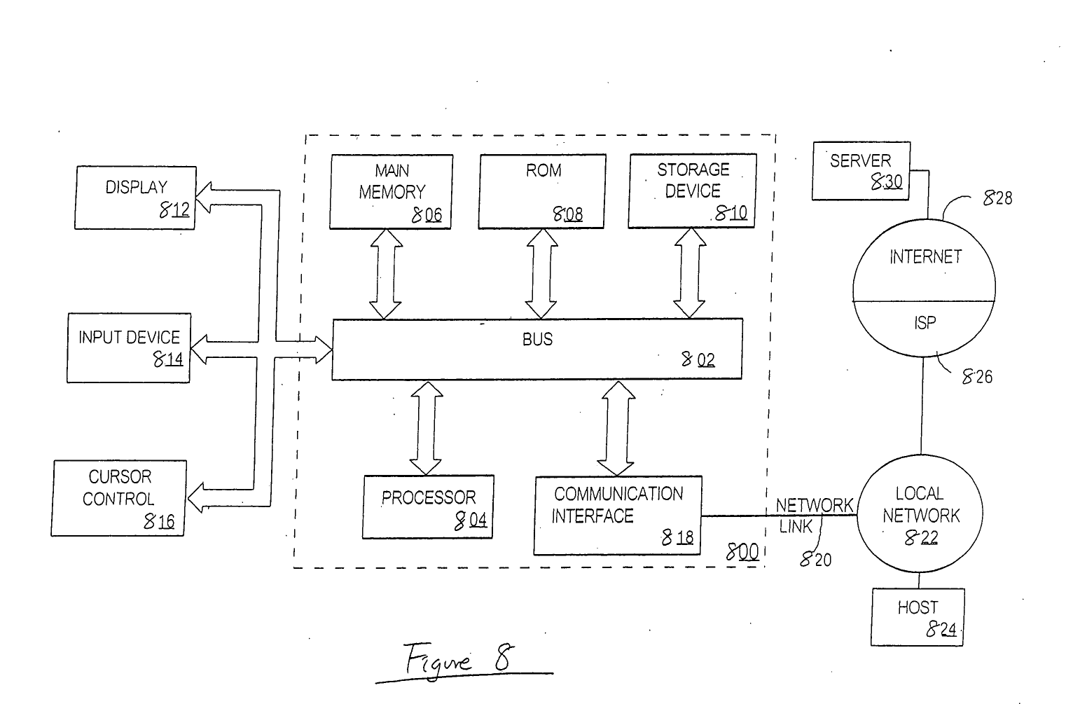

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A non-volatile storage device 810, such as a magnetic disk or optical disk, is provided and coupled to bus 802 for storing information and instructions and may store the persistent internal queue.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for processing event notification in a database system using a persistent internal queue. According to one embodiment of the invention, the processing of event notification in a database system is provided by computer system 800 in response to processor 804 executing one or more sequences of one or more instructions contained in main memory 806. Such instructions may be read into main memory 806 from another computer readable medium, such as storage device 810. Execution of the sequences of instructions contained in main memory 806 causes processor 804 to perform the process steps described herein. One or more processors in a multi-processing arrangement may also be employed to execute the sequences of instructions contained in main memory 806. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infrared transmitter to convert the data to an infrared signal. An infrared detector coupled to bus 802 can receive the data carried in the infrared signal and place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of carrier waves transporting the information.

Computer system 800 can send event notifications and receive data, including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, and/or stored in storage device 810, or other non-volatile storage for later execution. In this manner, computer system 800 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer implemented method for processing an event notification within a database notification infrastructure, said method comprising:
receiving an event registration, wherein said event registration specifies an event to be monitored, a subscriber, and a quality of service designation;
detecting occurrence of said event, wherein said event corresponds to said event registration;
generating an event notification related to said event registration;
enqueuing said event notification into a persistent internal queue of said database notification infrastructure provided said quality of service designation indicates a reliable event notification service designation.

2. The method as recited in claim 1 further comprising sending said event notification to an event monitor of said database system for transmission to said subscriber.

3. The method as recited in claim 1 further comprising delivering said event notification to a subscriber specified on said event registration.

4. The method as recited in claim 3, wherein said delivering is performed by an event monitor of said database system.

5. The method as recited in claim 3 further comprising removing said event notification from said persistent internal queue of said database notification infrastructure in response to said event notification being delivered to said subscriber.

6. The method as recited in claim 5, wherein said removing is performed by an event monitor of said database system.

7. The method as recited in claim 1, wherein said event to be monitored is a message being enqueued.

8. The method as recited in claim 1, further comprising enqueuing said event notification into a queue of volatile shared memory of said database notification infrastructure provided said quality of service designation indicates normal event notification service designation.

9. The method as recited in claim 1, wherein said event to be monitored is one of: a message being published to a queue, a message being enqueued, an instance going down, an instance going up, a database going down, a database going up, a database object changing, and an explicit post for a certain entity.

10. The method as recited in claim 1, wherein said persistent internal queue is non-volatile memory.

11. A computer system comprising:
a processor;
a bus coupled to said processor;
a memory coupled to said bus for storing instructions that when executed by the processor implements a method of processing an event notification within a database notification infrastructure, said method comprising:
receiving an event registration, wherein said event registration specifies an event to be monitored, a subscriber, and a quality of service designation;
detecting occurrence of said event, wherein said event corresponds to said event registration;
generating an event notification related to said event registration;
enqueuing said event notification into a persistent internal queue of said database notification infrastructure provided said quality of service designation indicates a reliable event notification service designation.

12. The computer system as recited in claim 11, wherein said method further comprises sending said event notification to an event monitor of said database system.

13. The computer system as recited in claim 11, wherein said method further comprises delivering said event notification to said subscriber specified on said event registration.

14. The computer system as recited in claim 13, wherein said delivering is performed by an event monitor of said database system.

15. The computer system as recited in claim 13, wherein said method further comprises removing said event notification from said persistent internal queue of said database notification infrastructure in response to said event notification being delivered to said subscriber.

16. The computer system as recited in claim 15, wherein said removing is performed by an event monitor of said database system.

17. The computer system as recited in claim 11, wherein said event to be monitored is a message being enqueued.

18. The computer system as recited in claim 11, wherein said method further comprises enqueuing said event notification into a queue of volatile shared memory of said database notification infrastructure provided said quality of service designation indicates normal event notification service designation.

19. The computer system as recited in claim 11, wherein said event to be monitored is one of: a message being published to a queue, a message being enqueued, an instance going down, an instance going up, a database going down, a database going up, a database object changing, and an explicit post for a certain entity.

20. The computer system as recited in claim 11, wherein said persistent internal queue is non-volatile.

21. A computer readable medium having stored therein instructions that when executed by a processor implement a method of processing an event notification within a database notification infrastructure, said method comprising:
receiving an event registration, wherein said event registration specifies an event to be monitored, a subscriber, and a quality of service designation;
detecting occurrence of said event, wherein said event corresponds to said event registration;
generating an event notification related to said event registration;
enqueuing said event notification into a persistent internal queue of said database notification infrastructure provided said quality of service designation indicates a reliable event notification service designation.

22. The computer readable medium as recited in claim 21, wherein said method further comprises sending said event notification to an event monitor of said database system.

23. The computer readable medium as recited in claim 21, wherein said method further comprises delivering said event notification to said subscriber specified on said event registration.

24. The computer readable medium as recited in claim 23, wherein said delivering is performed by an event monitor of said database system.

25. The computer readable medium as recited in claim 23, wherein said method further comprises removing said event notification from said persistent internal queue of said database notification infrastructure in response to said event notification being delivered to said subscriber.

26. The computer readable medium as recited in claim 25, wherein said removing is performed by an event monitor of said database system.

27. The computer readable medium as recited in claim 21, wherein said event to be monitored is a message being enqueued.

28. The computer readable medium as recited in claim 21, wherein said method further comprises enqueuing said event notification into a queue of volatile shared memory of said database notification infrastructure provided said quality of service designation indicates normal event notification service designation.

29. The computer readable medium as recited in claim 21, wherein said event to be monitored is one of: a message being published to a queue, a message being enqueued, an instance going down, an instance going up, a database going down, a database going up, a database object changing, and an explicit post for a certain entity.

30. The computer readable medium as recited in claim 21, wherein said persistent internal queue is non-volatile.
